(19) United States
(12) Patent Application Publication
(10) Pub. No.: US 2008/0166273 A1
(43) Pub. Date: Jul. 10, 2008

(54) Method And System For The Transformation Of Molecules, This Process Being Used To Transform Harmful And Useless Waste Into Useful Substances And Energy

(76) Inventor: Andrew E. Day, Longmeadow, MA (US)

Correspondence Address: Andrew Eric Day;Eric Day, 325 Williams Street, Longmeadow, MA, 01106, US

(21) Appl. No.: 11/620,018

(22) Filed: Jan. 4, 2007

(51) Int. Cl. B01D 53/00

(52) U.S. Cl. 422/174

(57) ABSTRACT

The system is based on a recirculating Carbon Flow Loop, within which toxins in municipal waste, or other feedstock, are neutralized in a plasma converter. This uses an electric arc in ionized gas to generate ultra high temperatures, which breaks down the feedstock into its basic elements, predominantly hydrogen and carbon monoxide (known as syngas). They can be further processed to yield additional hydrogen using an exothermal water shift reaction, or energy by using combustion. This transforms carbon monoxide into carbon dioxide. Unsaved hydrogen is turned into steam. Flow then continues in the carbon loop to an algae bioreactor. Here photosynthesis of algae transforms the carbon dioxide to become part of an oil rich carbohydrate. This can either continue to the next loop as feedstock, and/or exit the loop, and be used to manufacture biofuels or other substances, new feedstock being added to replace the exiting carbon.

### FIELD OF INVENTION

The planet is being poisoned by toxic waste, while waste is not being put to useful work:

1. Carbon Dioxide emissions from combustion engines, (used in Power Stations etc.) and rotting waste are creating global warming gasses. This could contribute to destroying the planet as we know it. The process may soon be irreversible.

2. Toxic waste from industrial factories and landfills is finding its way into our ground water supply.

3. Medical waste and dangerous bacteria need to be completely destroyed.

4. Landfills release methane into the atmosphere. Methane is rich in Hydrogen and has 20 times the effect of Carbon Dioxide as a global warming agent.

5. Landfills and other waste streams are not being utilized as a resource.

The need to address these problems is urgent and compelling.

It is known that Photosynthesis of algae creates carbohydrates by combining carbon dioxide with hydrogen. Plasma converters break down substances to their basic elements by exposing them to the very high temperatures of an electric arc in ionized gas. Hydrogen engines release energy for useful work and steam as the exhaust gas

This invention is a system which uses these processes and heat recovery techniques to form an efficient and practical way of cleaning up toxic waste and other refuse. By using landfills and other waste streams as a recoverable energy source we reduce our dependency on petroleum oil.

### BACKGROUND OF INVENTION

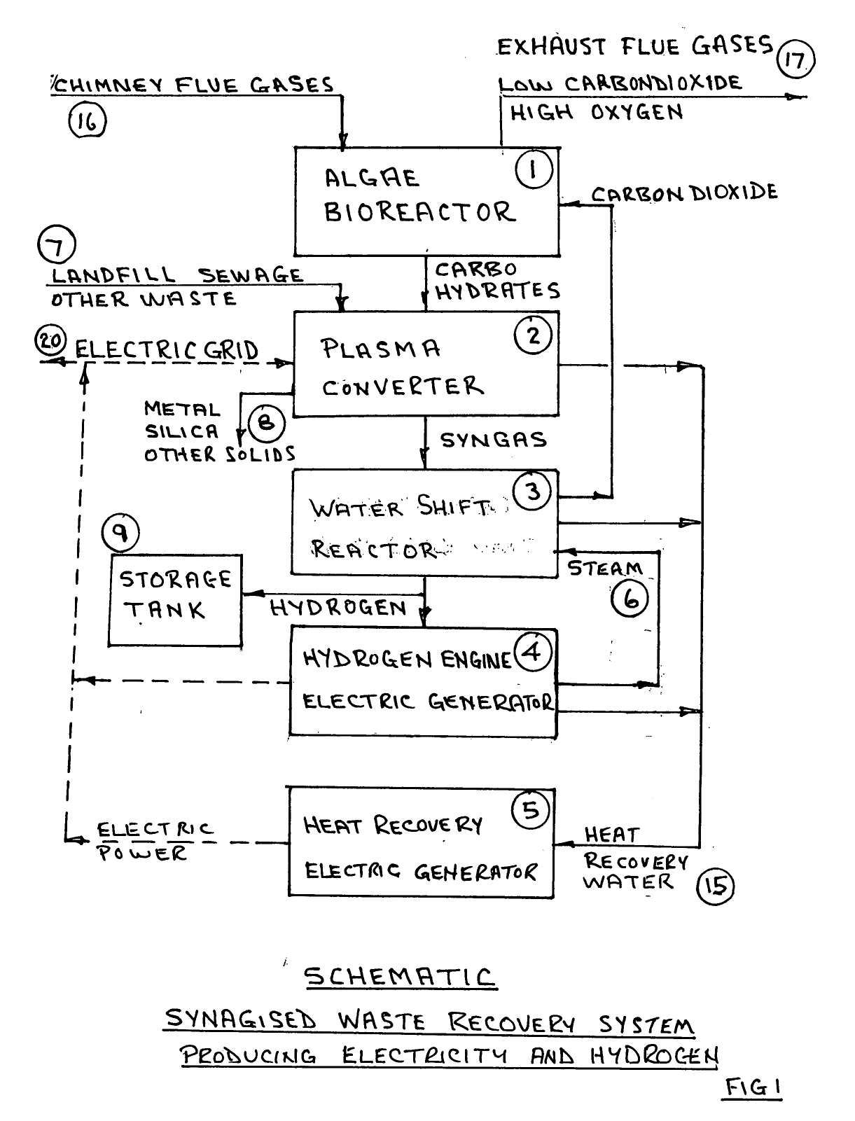

Building blocks for this system as shown in FIG. 1 are known:

1. Algae Bioreactors use high absorption algae, that in the presence of sunlight feed on carbon dioxide CO₂, to become a valuable source of oil rich carbohydrate. CO₂ is thus converted from a global warming pollutant into useful fuel feedstock rich in hydrogen.

2. Plasma Converters achieve temperatures hotter than the suns surface, by striking an electric arc though ionized gas, much in the same way as a lightning bolt. At these elevated temperatures molecules within compounds are converted into basic substances. Hydrocarbons and carbohydrates become split into carbon monoxide and hydrogen. Base metals and silica melt and form part of a molten discharge. This can be drained off to solidify on cooling to become a source for precious metal and silica recovery. The non precious slag can be used as a building material for industrial products.

3. Water Shift Reactors are used to combine oxygen with carbon monoxide to become carbon dioxide, bleed off hydrogen gas, and feed carbon dioxide gas back to the Algae Bioreactor i.e. Carbon Monoxide+Steam+Heat=>Carbon Dioxide+Hydrogen

CO+H₂O=>CO₂+H₂

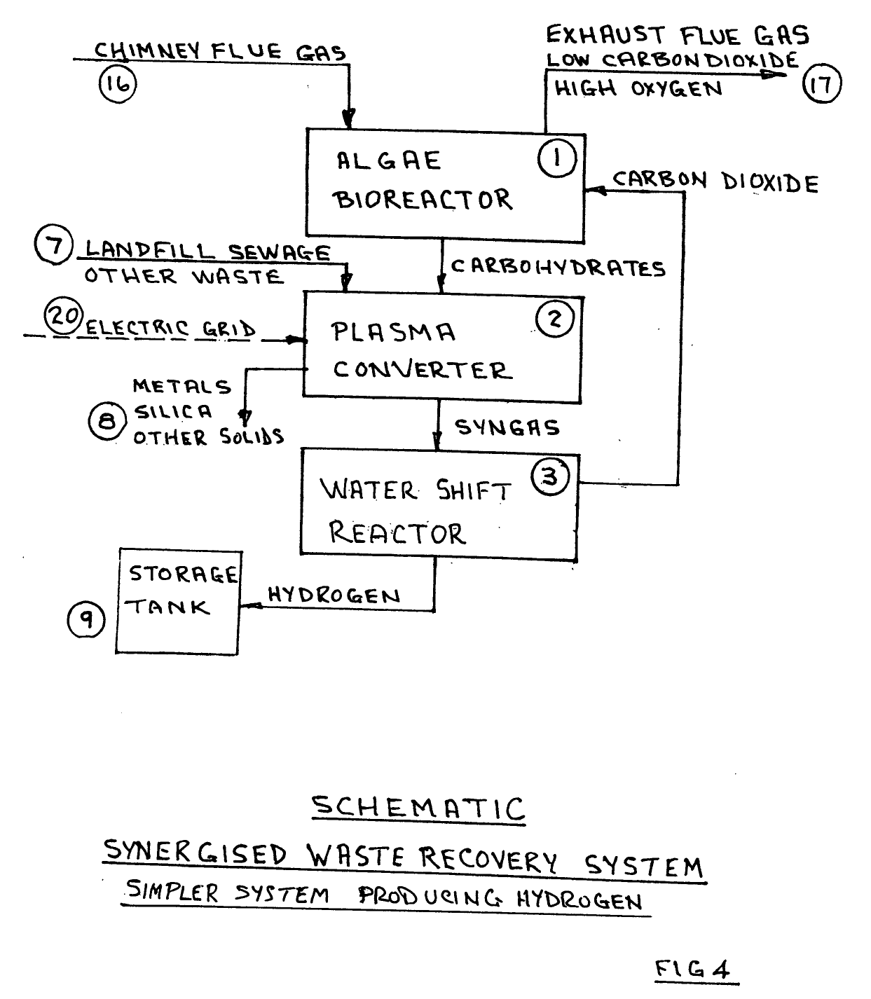

The availability of hot carbon monoxide from the Plasma Converter and hot steam from the Hydrogen Engine exhaust, ref. FIG. 4, result in this process being more economically viable. It was first discovered by Italian physicist Felice Fortana in 1780.

4. Hydrogen Engines are internal combustion engines which ignite hydrogen in the engine combustion chamber, and can be used to drive an electric generator or other devices. The exhaust gas from this process is a ready source of steam, which can be fed directly to a Water Shift Reactor, or stored as clean water for later use and recoverable energy.

5. Heat Recovery from the Plasma Converter, the Converter molten discharge, the Water Shift Reactor and the Hydrogen Engine can be used for many industrial processes, including a refrigerant turbine to power an electric generator. This unit uses the waste heat to evaporate refrigerant gas. This is used to power a low temperature gas turbine engine, which drives a generator, which supplements the electric power provided by the Hydrogen Engine.

### OBJECT OF INVENTION

1. It is the objective of the present invention to provide a method and system to generate electricity fueled from landfill, sewage or other waste streams, while neutralizing all toxins in the feedstock.

2. It is the objective of the present invention to provide a method and system to generate electricity while emitting low carbon dioxide (CO₂) greenhouse gasses (GHG)

3. It is the objective of the present invention to provide a method and system to generate electricity from day to day without interruption.

4. It is the objective of the present invention to provide a method and system to generate electricity while simultaneously removing carbon dioxide (CO₂) greenhouse gasses (GHG) from adjacent fossil fuel power station chimneys or other industrial facilities.

5. It is the objective of the present invention to provide a method and system to generate electricity, and produce Hydrogen while emitting low carbon dioxide (CO₂) greenhouse gasses (GHG)

6. It is the objective of the present invention to provide a method and system to produce hydrogen while emitting low carbon dioxide (CO₂) greenhouse gasses (GHG)

### SUMMARY OF INVENTION

The applicant has formulated an innovative and economical method of converting landfill waste, sewage, and other feedstock waste to provide hydrogen gas. A hydrogen, and a heat recovery engine are then used to drive generators to provide electric power. By storing some of the hydrogen a reserve fuel supply is maintained. Photosynthesis can only occur during sunlight hours. When the Algae Bioreactor is shut down due to lack of sunlight the hydrogen engine is operated from the reserve hydrogen fuel supply. The Algae Bioreactor consumes carbon dioxide emissions. In this way Carbon Dioxide carbon dioxide (CO₂) greenhouse gasses (GHG) are minimized

Variations on this proposal can be made to suit specific application, these are shown on FIGS. 1 through 6. Instead of generating electricity while producing hydrogen as shown in FIG. 1, the features of other optional configurations are listed below:

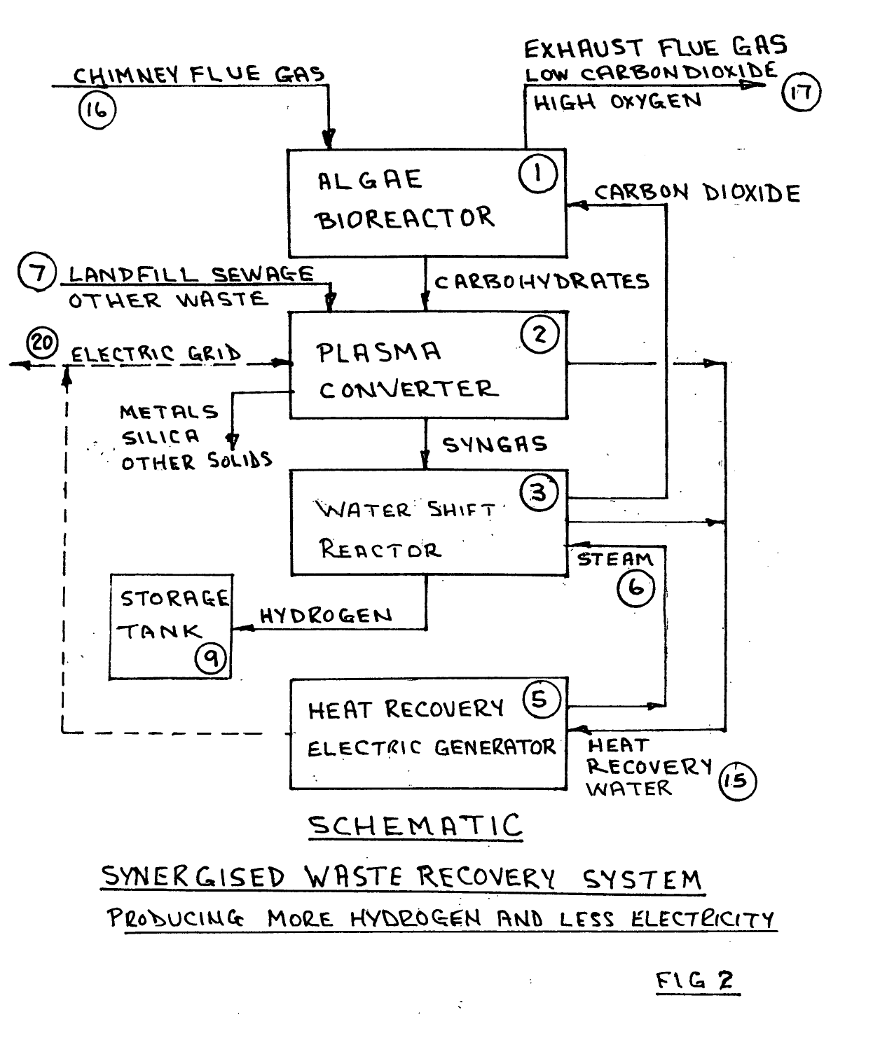

FIG. 2, Less electricity, more hydrogen lower cost

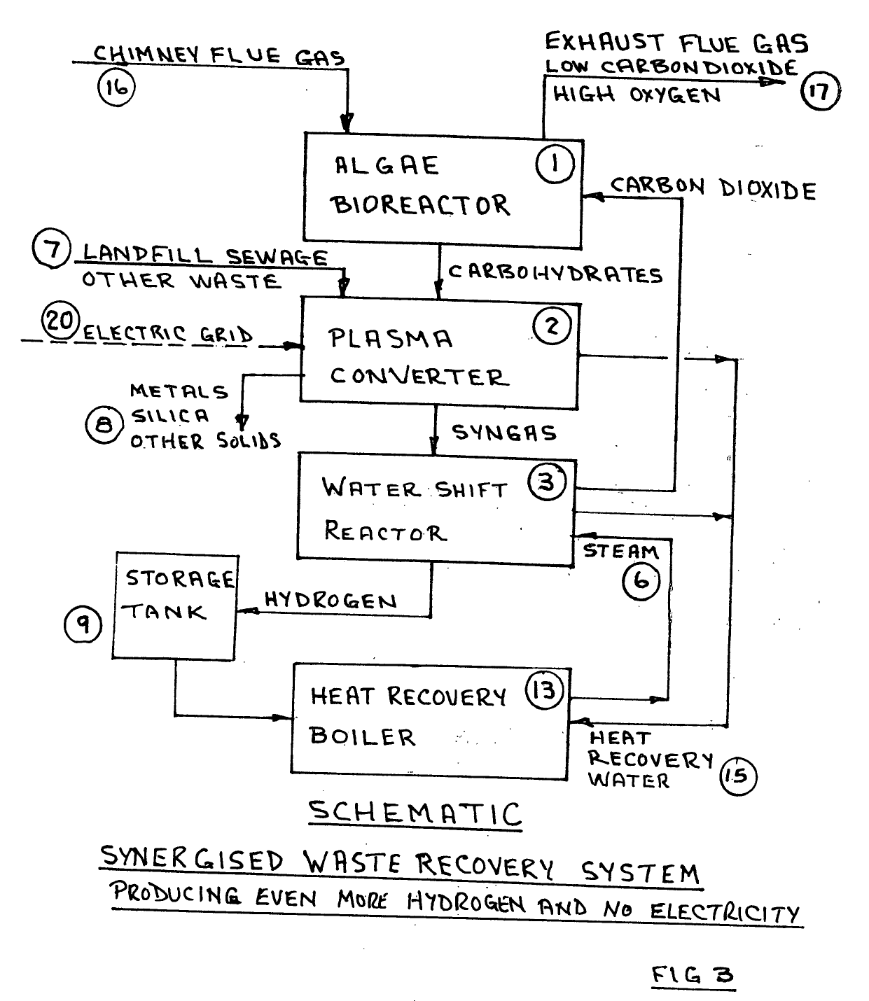

FIG. 3, No electricity, even more hydrogen even lower cost

FIG. 4, No electricity, similar hydrogen no heat recovery, no steam supply for the Water Shift Reactor.

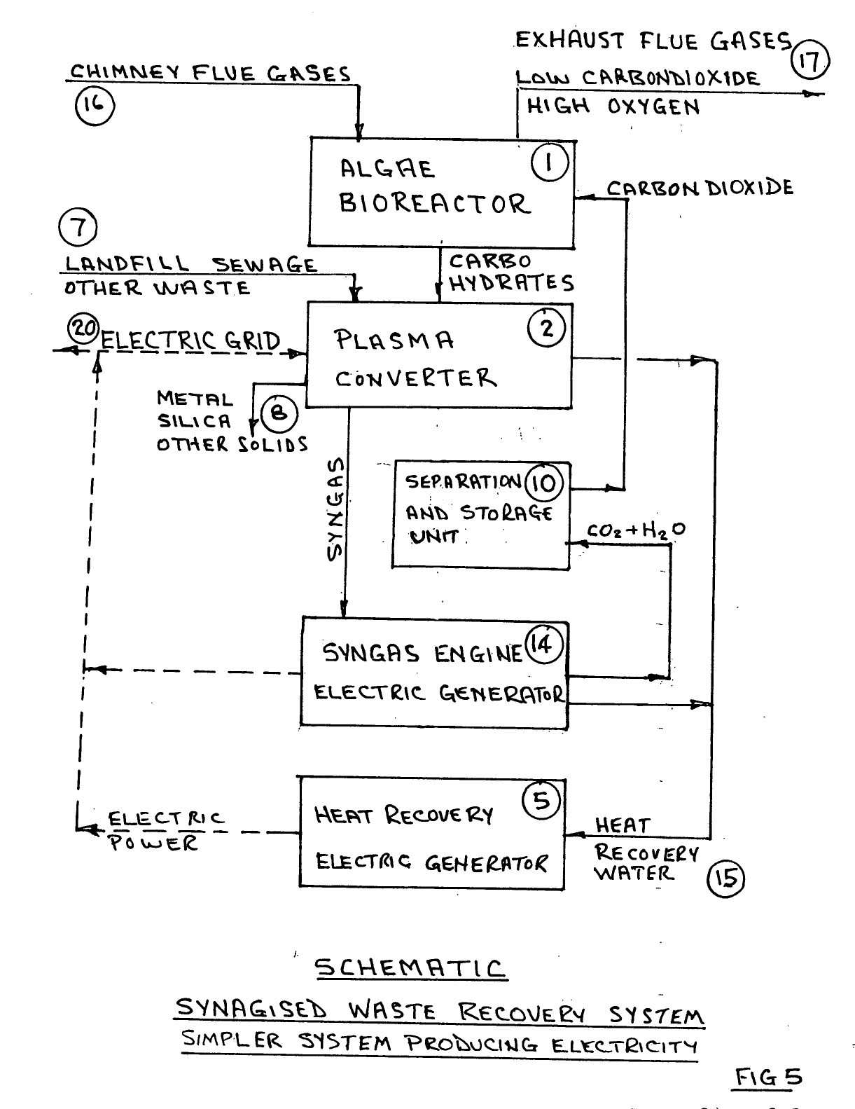

FIG. 5, No hydrogen production, more electricity

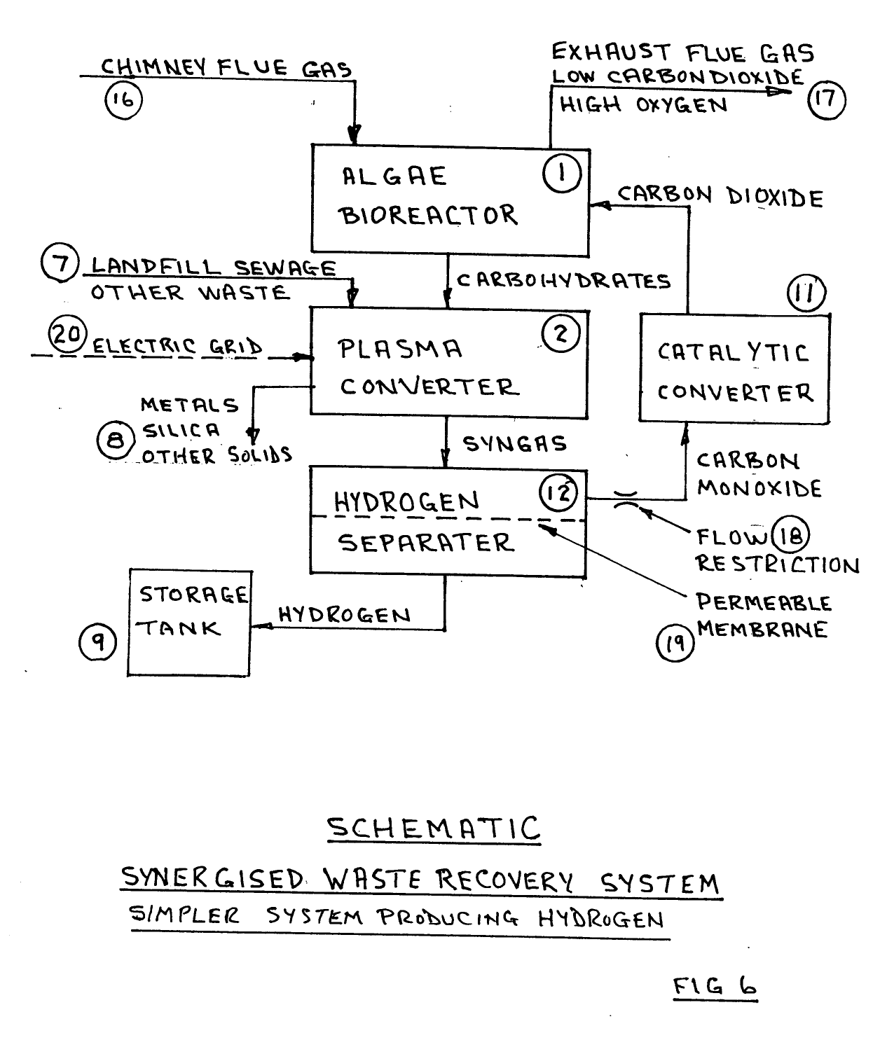

FIG. 6, No electricity, no heat recovery, even lower cost

### BRIEF DESCRIPTION OF DRAWINGS

Item 1. Algae Bioreactors, ref FIG. 1 through 6. Photosynthesis of the algae in the presence of sunlight creates carbohydrates by combining carbon dioxide with the hydrogen component of water. CO₂ is thus converted from a global warming pollutant into useful fuel feedstock rich in hydrogen. Surplus oxygen is vented to atmosphere.

Item 2. Plasma Converters, ref FIG. 1 through 6. Highly ionized gas known as plasma is a good conductor of electricity. A continuous electric arc struck within the plasma can produce temperatures greater than 30,000 degrees Fahrenheit (F). Within an oxygen depleted atmosphere at these temperatures both hazarded and non-hazardous materials in the feedstock are broken down into their basic elements. This is known as syngas. Municipal solid waste feedstock comprising typically of carbohydrates CH₂O and hydrocarbons CH₂ break down into similar amounts of carbon dioxide CO₂ and hydrogen H₂, with approximately 10% inert gasses.

Item 3. Water Shift Reactors, ref. FIGS. 1 through 4, are used in an endothermic process to combine steam (typically 2,000 F) with carbon monoxide to become carbon dioxide, and hydrogen gasses.

Item 4. Hydrogen Engines Electric Generators, ref. FIG. 4, is an internal combustion engine which ignites hydrogen and oxygen in an engine combustion chamber with high humidity.

Item 5. Heat Recovery Electric Generator, ref. FIG. 1, FIG. 2, and FIG. 3. Recovered waste heat, item 15, is used to evaporate refrigerant gas, and power a low temperature gas turbine engine, which drives an electric generator.

Item 6. Steam ref. FIG. 1 through 3. Hot steam Typically at 2,000 F is fed to the Water Shift Reactor.

Item 7. Landfill Sewage Other Waste, ref. FIGS. 1 through 6, is the primary feedstock used by these systems. Other hydrocarbon or carbohydrate based waste such as used truck or car tires, used engine oil or industrial waste are also suitable.

Item 8. Metal. Silica Other solids, ref. FIGS. 1 through 6, which do not gasify into their natural elements drain off in a molten discharge.

Item 9. Hydrogen Storage, ref. FIG. 1, FIG. 2, FIG. 3, FIG. 4 and FIG. 6, provides a means of storing hydrogen for later or other uses.

Item 10. Water Separation and Storage Unit, ref. FIG. 5. During combustion of the syngas, carbon dioxide and steam are formed. Heat transfer from the (Syngas Engine) exhaust gas, to a gas/water heat exchanger feeding Heat Recovery Electric Generator will lower the steam temperature to below boiling point. The storage tank will now contain water at the bottom and carbon dioxide above it.

Item 11. Catalytic Converter. Ref FIG. 6, converts carbon monoxide into carbon dioxide for digestion by the Algae Bioreactor. Heat generated by this process can be used to dry feedstock when needed.

Item 12. Permeable Membrane, ref FIG. 6. A fine porous membrane can be used, such that hydrogen can pass through it, but not larger molecules such as carbon dioxide.

Item 13. Heat Recovery Boiler, ref FIG. 3, uses the Heat Recovery Water supply, item 15, to feed a heat exchanger. This preheats the water input to the boiler. Following this the water is further heated into hot steam by combustion of hydrogen. This is used for endothermic operation of the Water Shift Reactor, item 3.

Item 14. Syngas Engine, ref. FIG. 5, is an internal combustion engine which ignites syngas (carbon monoxide and hydrogen) with oxygen in the engine combustion chamber. It is used to drive an electric generator. The exhaust “gasses” from this process are carbon dioxide and steam.

Item 15. Heat Recovery Water, ref FIG. 1 and FIG. 5. Heated water, item 15, is supplied by the Plasma Converter, item 2, Water Shift Reactor, item 3, and either Hydrogen Generator Engine, item 4, or Syngas Engine, item 14.

Item 16. Chimney Flue Gas, ref. FIGS. 1 through 6, when supplied from adjacent facilities after being suitably scrubbed and filtered to remove acids, pollutants and particulate matter, can be fed through the Algae Bioreactor Farm where carbon dioxide greenhouse gasses will be digested to form an oil rich carbohydrate.

Item 17. Exhaust Flue Gas, ref. FIGS. 1 through 6, from the Algae Bioreactor Farm will be vented to atmosphere. The targeted digestion rate of the algae is 80% to 90%. The 10% to 20% of carbon dioxide being released will also contain additional oxygen released during photosynthesis of the carbon dioxide input

Item 18. Flow Restriction, ref FIG. 6, is used to provide a pressure drop across the permeable membrane.

Item 19. Permeable Membrane, ref FIG. 6, is depicted

Item 20. Electric Grid, ref. FIG. 1 through 6, can receive power from the facility, or supply power to the facility.

### DESCRIPTION OF PREFERRED EMBODIMENT

As shown on FIG. 1 Carbohydrate/Hydrocarbon or other feedstock is fed to the Plasma Converter (Item 2) from the Waste Supply Input (Item 7) and from the Algae Bioreactor (Item 1). Syngas is then fed from the Plasma Converter to the Integrated Gasification Combined Cycle unit (Item 3). With steam input the carbon monoxide is converted into carbon dioxide and fed back to the Algae Bioreactor. Hydrogen is also filtered out and fed to the Hydrogen Engine (Item 4) and Hydrogen Storage Tank (Item 6). The Hydrogen Engine is an uninterrupted source of electric power. It is used to drive an electric generator, and provides hot engine cooling water to the Energy recovery system. The exhaust “Gas” is steam and is used by the Water Shift Reactor to lower operating costs. Heat is also recovered from the Plasma Converter molten byproducts (Item 8), and the Plasma Converter and Water Shift Reactor cooling jackets. To improve overall operating efficiency, recovered heat is used to evaporate refrigerant gas, which powers a low temperature gas turbine engine (Item 5) This drives a generator, which supplements the electric power provided by the Hydrogen Engine. A byproduct of the Plasma Converter (Item 2) operation is the base metals, silica and other solids which melt and form part of a molten discharge (Item 8). This can be drained off to solidify on cooling and become a source for precious metal recovery. The silica and other products can be recovered as a building material for many industrial products and uses. As shown on the embodiment shown in FIG. 2, the FIG. 1 system is modified to omit item 4 the Hydrogen Engine Electric Generator. This embodiment is better suited for applications where more hydrogen is required (to be stored in item 9) as the final product. Supplemental heat may be requires to boil the heat recovery water into hot (approx. 2000 F) steam (Item 6). This embodiment reduces the electric power which can be supplied to the electric grid but also reduces the initial capital cost of the system

As shown on the embodiment shown in FIG. 3, the FIG. 1 system is modified to omit item 4 the Hydrogen Engine Electric Generator and item 5 the Heat recovery Electric Generator. Item 5 is replaced by item 13, a Heat Recovery Boiler. This embodiment is better suited for applications where only hydrogen is required (to be stored in item 9) as the final product. This embodiment does not provide any electric power to the electric grid but reduces the initial capital cost of the system.

As shown on the embodiment shown in FIG. 4, the FIG. 1 system is modified to omit item 4 the Hydrogen Engine Electric Generator, item 5 the Heat recovery Electric Generator, and the Heat recovery System item 15. This embodiment omits steam injection into the Water shift Reactor but further reduces the initial capital cost of the system.

As shown on the embodiment shown in FIG. 5, the FIG. 1 system is modified to omit item 3 the Water shift Reactor, and item 4 the Hydrogen Engine Electric Generator. These are replaced by item 14 the Syngas Engine Electric Generator and item 10, the engine exhaust gas Water Separator And Storage unit. This embodiment does not provide any hydrogen gas but reduces the initial capital cost of the system.

As shown on the embodiment shown in FIG. 6, the FIG. 1 system is modified to omit item 3 the Water shift Reactor, and item 4 the Hydrogen Engine Electric Generator and item 5 the Heat recovery Electric Generator, and item 15 the Heat recovery System. These are replaced by item 12 a Hydrogen Separator and item 11 a Catalytic Converter. The Hydrogen Separator item 12 incorporates a Hydrogen Permeable Membrane which allows the small hydrogen molecules to pass through it. The rest of the Syngas flows through a restricted passage to the Catalytic Converter where carbon monoxide is converted to carbon dioxide. This is then fed back to the Algae Bioreactor to continue the cycle. This embodiment does not provide any electric power but further reduces the initial capital cost of the system.

It will be apparent to a person of ordinary skill in the art, that various modifications and variations can be made to the system for operating the generating system without departing from the scope and spirit of the invention. It will also be apparent to a person of ordinary skill in the art that various modifications and variations can be made to the size and capacity of the eight (20) items shown on FIG. 1 through 6 without departing from the scope and spirit of this invention. Thus it is intended that the present invention cover the variations and modifications of the invention, provided they come within the scope of the appended claims and their equivalents.

1. A method and system for controlling an electric generating system using Carbohydrates/Hydrocarbons from landfills or sewage systems or other feedstocks,

2. A method and system for controlling an electric generating system while emitting low carbon dioxide (CO₂) greenhouse gasses (GHG)

3. A method and system for controlling an electric generating system for continuous power generation. Peak power output occurs during daytime hours.

4. A method and system for controlling an electric generating system while simultaneously removing carbon dioxide (CO₂) greenhouse gasses (GHG) from adjacent fossil fuel power station chimneys or other industrial facilities.

5. A method and system for controlling an electric generating system to eliminate landfills, sewage, and hydrocarbon/carbohydrate or other feedstock without generating toxic waste. This elimination will also avoid methane being released into the atmosphere, which if from an adjacent landfill or other source could be fed into the Plasma Reactor as a feed stock.

6. A method and system for controlling an electric generating system which retains precious metals, silica and other solids found in the feedstock, for further use

7. A method and system for controlling an electric generating system which recovers energy from waste heat to provide additional electric power generation or thermal energy for other purposes.

8. Variations on the basic design shown in FIG. 1. These will adapt the system to specific system requirements, and are shown on FIGS. 2 through 6. They including producing both electricity and hydrogen, electricity only, and hydrogen only. The omission of feature will impact flexibility, design complexity, and operating cost.
